(19) United States
(12) Patent Application Publication
(10) Pub. No.: US 2009/0234982 A1
(43) Pub. Date: Sep. 17, 2009

(54) Method of identifying and dynamically updating storage device status at target

(75) Inventors: Hong-Ming Li, Tianjin (CN); Ming-Sheng Zhu, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/076,043

(22) Filed: Mar. 13, 2008

(51) Int. Cl. G06F 3/00

(52) U.S. Cl. 710/19

(57) ABSTRACT

A method of identifying and dynamically updating storage device status at a target is applied for a storage area network (SAN) built by Linux system, for determining operating status of storage devices at a target through logic device identification numbers. First, a session is established between an initiator and the target, and allocated storage devices and corresponding logic unit numbers (LUNs) are obtained. Then, the initiator sends a CMD request packet with report LUN command to the target. Afterward, according to the LUNs in a received CMD response packet, operating status corresponding to the storage devices is determined. Thereby, timeout may be reduced by avoiding sending queries to those storage devices. When the device allocation is modified, the target may send an asynchronous message PDU to update a storage device status record at the target, so as to maintain the usability of the record.

### BACKGROUND OF THE INVENTION

1. Field of Invention

The present invention relates to a method of maintaining a storage area network (SAN), and more particularly to a method of maintaining storage device status at a target through a report logic unit number (LUN) command.

2. Related Art

Internet small computer systems interface (iSCSI) is a standard of communication protocol proposed by IETF. The iSCSI is connected to several computer hosts via TCP/TP protocol, such that multiple storage devices distributed in the Internet are serially-connected to sever as a virtual network storage device. A user accesses the network storage device just like accessing a local hard disk device. Compared with conventional SCSI and RAID technologies, the iSCSI technology has the high-speed transmission capability of SCSI, and is not limited to the expansion/backup capability of the storage devices, so the capacity of the virtual storage device may be infinitely expanded. The virtual storage device is referred to as a storage area network (SAN), and is mainly constituted by an initiator and a target. The initiator sends an access request and establishes a session with the target. The target may be regarded as a manager/an allocator of available storage device resources in the network, so as to allocate corresponding logic unit numbers (LUNs) to the storage devices. The LUNs function as virtual logical volumes (LVs), and each LUN is corresponding to one or more physical storage devices in the network.

To query/access data, the initiator generally starts polling from the 0^{th} LUN (LUN 0) of the target in sequence. After sending a query request command, the initiator waits for a response packet. If the initiator has not received the response packet containing LUN 0 from the target for a long time, the device corresponding to LUN 0 does not exist. At this time, the initiator continues querying the next LUN till finding an available LUN through polling. However, such polling manner may waste quite a long time in waiting, thus bringing inconvenience to network storage device users.

### SUMMARY OF THE INVENTION

Accordingly, as it is rather time-consuming for polling the logic unit numbers (LUNs), the present invention is directed to a method of maintaining LUN status at a target of a storage area network (SAN), in which the corresponding storage device status is maintained by a response packet containing the LUN, so as to avoid the failure of LUN polling, and reduce the time for polling.

In order to achieve the above objectives such as avoiding the failure of LUN polling, a method of identifying storage device status at a target is provided. In an SAN built by Linux system, operating status of storage devices at a target is determined through logic device identification numbers. The method of identifying storage device status at a target includes the following steps. First, an initiator establishes a session with the target, and obtains a plurality of allocated storage devices and corresponding LUNs. Next, the initiator writes a report LUN command into a command descriptor block (CDB), packages the CDB into an SCSI CMD request packet, and sends the SCSI CMD request packet to the target. Afterward, the initiator receives a feedback SCSI CMD response packet, and parses all the LUNs carried by the SCSI CMD response packet. Finally, the initiator compares the allocated LUNs with the LUNs obtained from the SCSI CMD response packet to see whether the storage devices are modified, thereby updating the status of the storage devices.

In the method of identifying storage device status at a target according to a preferred embodiment of the present invention, the initiator stores the allocated LUNs in an LUN array, and records connection status of the storage devices corresponding to the LUNs in an LUN status array.

In the method of identifying storage device status at a target according to a preferred embodiment of the present invention, the initiator further sends the SCSI CMD request packet for polling the corresponding LUNs according to the connection status recorded in the LUN status identification array.

In the method of identifying storage device status at a target according to a preferred embodiment of the present invention, the command contained in the SCSI CMD request packet is one selected from a group consisting of a polling command, an operating mode detection command, a read/write ability command, and a read/write test command.

A method of dynamically updating storage device status at a target is also provided. The method includes the following steps. First, when a device allocation is added or removed at the target, the target sends an asynchronous message PDU to an initiator. Next, the initiator receives the asynchronous message PDU, and parses a sense data in the asynchronous message PDU, so as to identify whether a device allocation is added or removed at the target. Afterward, the initiator writes a report LUN command into a CDB, packages the CDB into an SCSI CMD request packet, and sends the SCSI CMD request packet to the target. Then, the initiator receives a feedback SCSI CMD response packet, and parses the LUNs carried by the SCSI CMD response packet. Finally, the initiator compares all the allocated LUNs with the LUNs obtained from the SCSI CMD response packet, and updates the status of the corresponding storage devices.

In view of the above, the initiator sends a report LUN command to the target in the form of an SCSI command packet. After receiving the SCSI command packet, the target collects and feeds back the currently available LUN information to the initiator. The initiator learns about the modification of the storage devices at the target in real time by comparing the feedback LUN information without accessing the invalid LUNs, thereby avoiding wasting time due to timeout in accessing the LUNs.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a method of identifying storage device status at a target according to a first embodiment of the present invention.

FIG. 2 is a schematic view of packet transmission between the initiator and the target according to the first embodiment of the present invention.

FIG. 3 is a flow chart of a method of dynamically updating storage device status at a target according to a second embodiment of the present invention.

FIG. 4 is a schematic view of packet transmission between the initiator and the target according to the second embodiment of the present invention.

### DETAILED DESCRIPTION OF THE INVENTION

The objectives and the method of identifying storage device status at a target provided by the present invention will be illustrated in detail below with preferred embodiments. However, the concept of the present invention is also applicable in other scopes. The following embodiments are only used for illustrating the objectives and implementing methods of the present invention, instead of limiting the scope thereof.

### First Embodiment

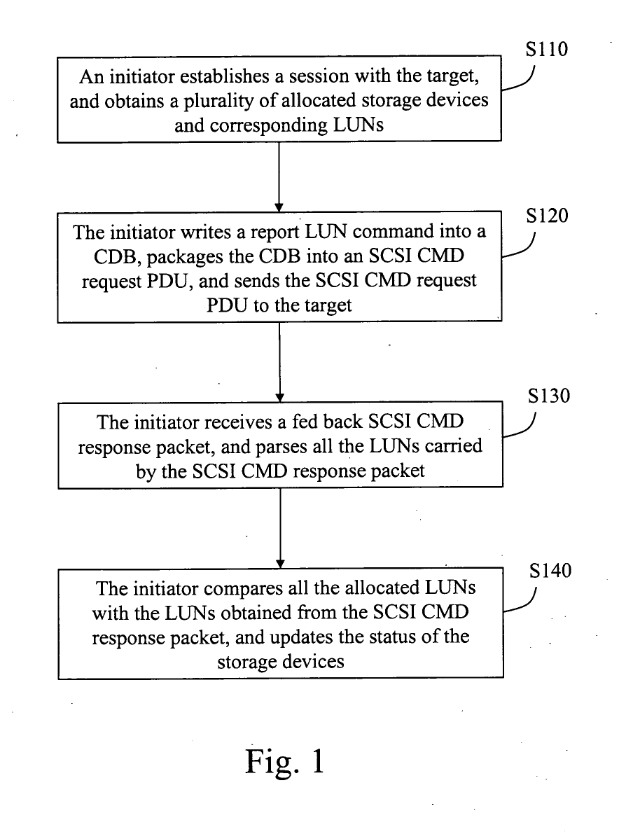

In a first embodiment, a storage area network (SAN) is a virtual large-scale storage device constituted by several computer systems with a Linux execution environment. When a session is established between an initiator and a target, the initiator determines operating status of storage devices at the target through logic device identification numbers. FIG. 1 is a flow chart of a method of identifying storage device status at a target according to the first embodiment of the present invention. Referring to FIG. 1, first, the initiator establishes a session with the target, and obtains a plurality of allocated storage devices and corresponding logic unit numbers (LUNs) (Step S110). Next, the initiator writes a report LUN command into a command descriptor block (CDB), packages the CDB into an SCSI CMD request packet, and sends the SCSI CMD request packet to the target (Step S120). Afterward, the initiator receives a feedback SCSI CMD response packet, and parses all the LUNs carried by the SCSI CMD response packet (Step S130). Finally, the initiator compares all the allocated LUNs with the LUNs obtained from the SCSI CMD response packet, and updates the status of the storage devices (Step S140).

During the initialization, the initiator establishes an LUN array, for example, Lun_list[MAX_LUN], and an LUN status array, for example, Lun_at_target[MAX_LUN]. When a session is established between the initiator and the target, the initiator sends a report LUN command to obtain one (or more) allocated LUN(s). If ten LUNs are obtained, a MAX_Lun variable is set as 9 (i.e., establishing an array with ten groups of Lun information), and the LUN array is used for storing the LUNs allocated by the target. Meanwhile, an LUN status array (also containing a recording space of ten groups of Lun information) is established for recording connection status of the storage devices corresponding to the LUNs.

When the session is just established, no data is stored in the LUN array. Then, the target writes a report LUN command into the CDB, packages the CDB into an iSCSI CMD request packet, and sends the iSCSI CMD request packet to the target, so as to retrieve and record all the currently available LUNs at the target into the LUN array. For example, if the obtained Lun numbers are 3, 4, 5, 7, and 9, the feedback Lun numbers are recorded into the LUN status array Lun_at_target[9]={0,0,0,1,1,1,0,1,0,1}, and the Luns are 3, 4, 5, 7, and 9 are polled in sequence.

If the target returns that the connection status of the Luns 3, 4, 5, 7, and 9 is accessible/on line, the LUN array is set as Lun_list[9]={0,0,0,1,1,1,0,1,0,1}. Afterward, if the initiator intends to poll available LUNs, it is unnecessary to start polling from Lun 0, and the currently available LUNs are polled directly (i.e., sequentially polling LUNs recorded in the LUN array as 1, i.e., the Luns 3, 4, 5, 7, and 9).

The target may poll the LUNs through the SCSI CMD request packet, and the available SCSI command is one selected from a group consisting of a polling command, an operating mode detection command, a read/write ability command, and a read/write test command. For example, when the LUNs at the target are obtained through the report LUN command, a query command such as Inquiry, or Read_Capacity is used to obtain and present relative hardware information to the subscriber. Further, the aforementioned polling command, operating mode detection command, read/write ability command, and read/write test command are respectively used for making sure whether any LUN responds, detecting operating modes of the storage devices corresponding to the LUNs, detecting read/write abilities of the storage devices corresponding to the LUNs, and detecting whether read/write functions of the storage devices corresponding to the LUNs are normal.

After the SAN operates for a period of time, the initiator again sends an iSCSI CMD request packet containing the report LUN command to the target, so as to retrieve and record all the LUNs at the target currently into the LUN status array. For example, if the retrieved LUNs are Luns 5, 6, 7, and 9, the LUN status array is set as Lun_at_target[9]={0,0,0,0,0,1,1,1,0,1}. At this time, the target compares records in the LUN array Lun_list[9] with those in the LUN status array Lun_at_target[9].

If an element Lun_list[N] in the LUN array is 0, and an element Lun_at_target[N] is recorded in the LUN status array as 1, the Lun N is an LUN newly added at the target during this period of operating time, for example, Lun 6. Then, the initiator calls a system interface to send an SCSI CMD request packet to the target, so as to obtain the message of the newly added storage device. On the contrary, if an element Lun_list[N] in the LUN array is 1, and an element Lun_at_target[N] is recorded in the LUN status array as 0, the Lun N is an LUN removed from the target, for example, Lun 3 or Lun 4. Then, the initiator calls a system interface to inform an SCSI mid layer that the corresponding storage device is removed.

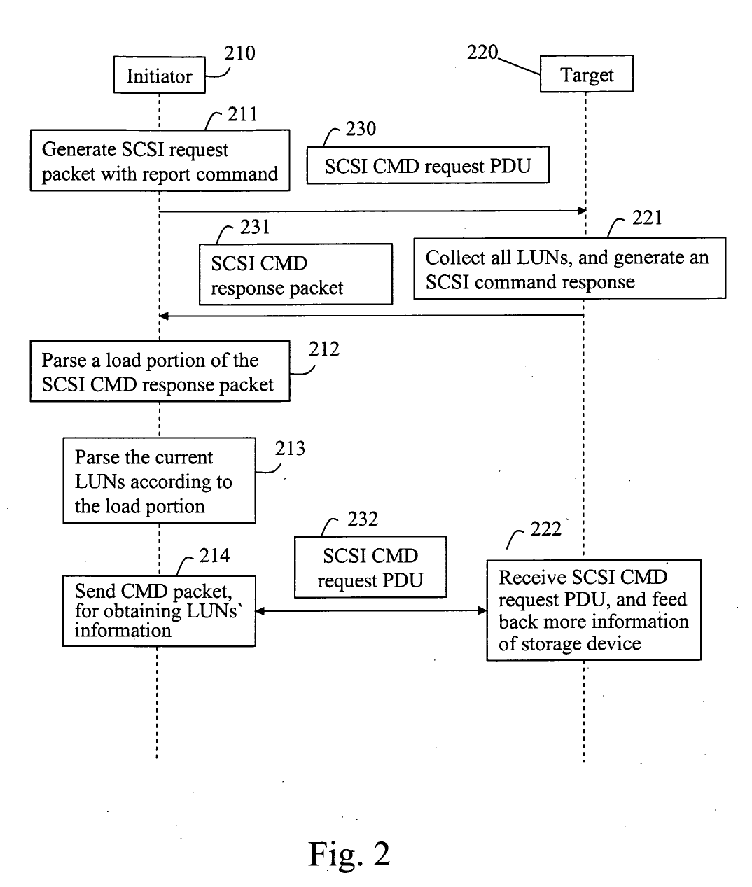

FIG. 2 is a schematic view of packet transmission between the initiator and the target according to the first embodiment of the present invention. Referring to FIG. 2, after being initialized, the initiator 210 generates an SCSI request packet 211 containing a report command, and sends the packet 230 to a target 220. On receiving the packet 230, the target collects all the LUNs corresponding to the storage devices connected to the target, and generates an SCSI command response (i.e., the operation shown in Block 221). Then, the target 220 generates an SCSI CMD response packet 231 according to the command response, and feeds back the SCSI CMD response packet 231 to the initiator 210. Thereafter, the initiator 210 parses a payload 212 of the SCSI CMD response packet, and parses all the currently available LUNs 213 at the target according to the payload. Finally, the initiator 210 sends an SCSI CMD request packet 232 to the target 220, so as to obtain a more specific storage device information 222.

### Second Embodiment

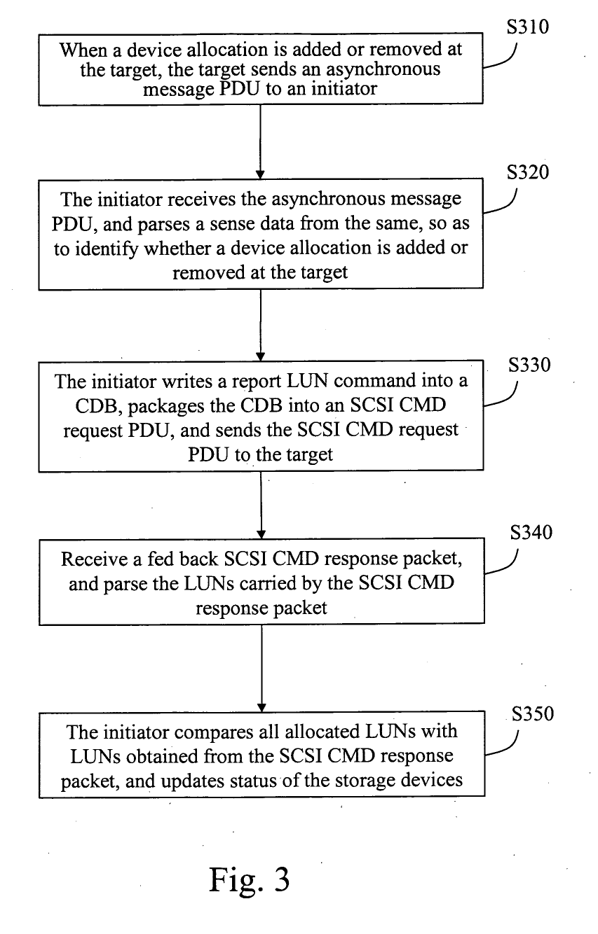

FIG. 3 is a flow chart of a method of dynamically updating storage device status at a target according to a second embodiment of the present invention. Referring to FIG. 3, first, when a device allocation is added or removed at the target, the target sends an asynchronous message PDU to an initiator (Step S310). Next, the initiator receives the asynchronous message PDU, and parses a sense data from the asynchronous message PDU, so as to identify whether a device allocation is added or removed at the target (Step S320). Afterward, the initiator writes a report LUN command into a CDB, packages the CDB into an SCSI CMD request packet, and sends the SCSI CMD request packet to the target (Step S330). Then, the initiator receives a feedback SCSI CMD response packet, and parses the LUNs carried by the SCSI CMD response packet (Step S340). Finally, the initiator compares all the allocated LUNs with the LUNs obtained from the SCSI CMD response packet, and updates the status of the storage devices (Step S350), for example, connection status, connection capability, or read/write ability of the storage devices. In addition, the target detects whether a device is added or removed at the target through, for example, changes in the potential of the pins, or transmission packets received from the remote storage devices.

The second embodiment is similar to the first embodiment, in which the initiator sends an iSCSI CMD request packet containing a report LUN command to the target to retrieve all the LUNs at the target, and then compares the retrieved LUNs with the available LUNs recorded in the initiator, so as to update operating status of the storage devices recorded in the initiator. The major difference between the second and the first embodiment is that, the second embodiment further detects any transaction (adding or removing) of the storage devices at the target. The detection of the transaction of the storage devices at the target is described in detail below, and the other steps identical to those of the first embodiment will not be repeated herein again.

Whenever a storage device is added or removed at the target, the target sends a sense data packet to the initiator, for example, an asynchronous message PDU, such that the initiator may identify whether a device transaction such as adding or removing occurs at the target. A segment of the sense data is shown as follows:
UNIT ATTENTION
ASC: Additional Sense Code
ASCQ: Additional Sense Code Qualifier
asc=0x3f, ascq=0x0e: REPORED LUNS DATA HAS CHANGED
asc=0x28, ascq=0x00: TARGET OPERATING CONDITIONS HAVE CHANGED

After obtaining the asynchronous message PDU of the iSCSI, the initiator parses the sense data in the packet. If the sense data is UNIT ATTENTION, and asc=0x3f, ascq=0x0e or asc=0x28, ascq=0x00, it is determined that a transaction occurs at the target, and the iSCSI CMD request packet containing the report LUN command is sent to the target, so as to update the LUN information at the initiator.

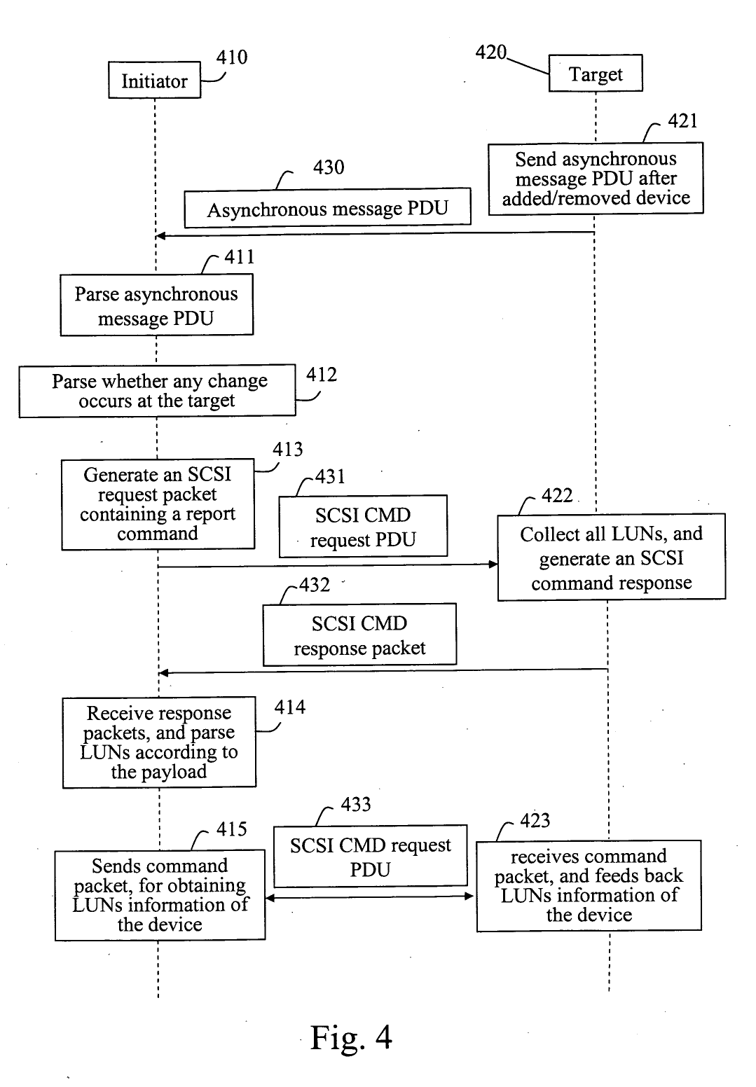

FIG. 4 is a schematic view of packet transmission between the initiator and the target according to the second embodiment of the present invention. Referring to FIG. 4, after a storage device is added or removed at the target 420, the target 420 sends an asynchronous message PDU (i.e., the operation shown in Block 421) to an initiator 410. Next, the initiator 410 receives the asynchronous message PDU 430, parses a payload from the asynchronous message PDU 430, and obtains the sense data (i.e., the operation shown in Block 411). Then, the initiator 410 parses whether any change occurs at the target according to the sense data (i.e., the operation shown in Block 412), and generates an SCSI request packet containing a report command (i.e., the operation shown in Block 413). After receiving the SCSI CMD request packet 431, the target 420 collects all the available LUNs at the target 420, and generates an SCSI command response (i.e., the operation shown in Block 422). The SCSI command response is further written into the SCSI CMD response packet 432, and feed back to the initiator 410. On receiving response packets, the initiator 410 parses all the LUNs at the target 420 according to payload of the packet (i.e., the operation shown in Block 414). Further, the initiator 410 sends a command packet (i.e., an SCSI CMD request packet 433) to the target 420, so as to obtain specific device messages of the storage devices corresponding to the LUNs (i.e., the operation shown in Block 415). Finally, the target 420 operates according to the received command, and returns detailed device information of the storage devices corresponding to the LUNs (i.e., the operation shown in Block 423).

What is claimed is:

1. A method of identifying storage device status at a target, applied in a storage area network (SAN) built by Linux system, for determining operating status of storage devices at a target through logic device identification numbers, the method comprising:
an initiator establishing a session with the target, and obtaining a plurality of allocated storage devices and a plurality of corresponding logic unit numbers (LUNs);
the initiator writing a report LUN command into a command descriptor block (CDB), packaging the CDB into a small computer systems interface (SCSI) CMD request packet, and sending the SCSI CMD request packet to the target;
receiving a feedback SCSI CMD response packet, and parsing the LUNs carried by the SCSI CMD response packet; and
the initiator comparing the allocated LUNs with the LUNs obtained from the SCSI CMD response packet, and updating the status of the storage devices.

2. The method of identifying storage device status at a target as claimed in claim 1, wherein the initiator stores the allocated LUNs in an LUN array.

3. The method of identifying storage device status at a target as claimed in claim 2, wherein the initiator records connection status of the storage devices corresponding to the LUNs in an LUN status array.

4. The method of identifying storage device status at a target as claimed in claim 3, wherein the initiator sends the SCSI CMD request packet for polling the LUNs according to the connection status recorded in the LUN status identification array.

5. The method of identifying storage device status at a target as claimed in claim 1, wherein a command contained in the SCSI CMD request packet is one selected from a group consisting of a polling command, an operating mode detection command, a read/write ability command, and a read/write test command.

6. A method of dynamically updating storage device status at a target, applied in a storage area network (SAN) built by Linux system, for determining operating status of storage devices of a target through logic device identification numbers, the method comprising:
when a device allocation is added or removed at the target, the target sending an asynchronous message PDU to an initiator;
the initiator receiving the asynchronous message PDU, and parsing a sense data from the asynchronous message PDU, so as to identify whether a device allocation is added or removed at the target;
the initiator writing a report logic unit number (LUN) command into a command descriptor block (CDB), packaging the CDB into a small computer systems interface (SCSI) CMD request packet, and sending the SCSI CMD request packet to the target;
receiving a feedback SCSI CMD response packet, and parsing the LUNs carried by the SCSI CMD response packet; and
the initiator comparing the allocated LUNs with the LUNs obtained from the SCSI CMD response packet, and updating the status of the storage devices.

7. The method of dynamically updating storage device status at a target as claimed in claim 6, wherein the initiator stores the allocated LUNs in an LUN array.

8. The method of dynamically updating storage device status at a target as claimed in claim 7, wherein the initiator records connection status of the storage devices corresponding to the LUNs in an LUN status array.

9. The method of dynamically updating storage device status at a target as claimed in claim 8, wherein the initiator sends the SCSI CMD request packet for polling the LUNs according to the connection status recorded in the LUN status identification array.

10. The method of dynamically updating storage device status at a target as claimed in claim 6, wherein a command contained in the SCSI CMD request packet is one selected from a group consisting of a polling command, an operating mode detection command, a read/write ability command, and a read/write test command.
